(19) United States
(12) Patent Application Publication
(10) Pub. No.: US 2005/0098928 A1
(43) Pub. Date: May 12, 2005

(54) Method for producing biodegradable packing from biaxially drawn film

(76) Inventors: Sonja Rosenbaum, Bous (DE); Marlies Rosenbaum, Bous (DE); Jurgen Schischko, Neunkirchen-Furpach (DE); Detlef Busch, Saarlouis (DE)

Correspondence Address: Connolly Bove;Lodge & Hutz, 1220 Market Street, PO Box 2207, Wilmington, DE, 19899, US

(21) Appl. No.: 10/471,274

(22) PCT Filed: Mar. 7, 2002
(86) PCT No.: PCT/EP02/02513

(30) Foreign Application Priority Data
Mar. 9, 2001 (DE) 101 11 686.1

(51) Int. Cl. B29C 55/00

(52) U.S. Cl. 264/492; 264/290.2; 264/554; 525/444

(57) ABSTRACT

The invention relates to a method for producing a plastically moulded, biaxially drawn PLA film. According to said method, a biaxially drawn PLA film is heated to a high temperature and is plastically moulded by a pneumatic or mechanical force, or by a combination of pneumatic and mechanical force. The invention also relates to packaging produced from biaxially drawn, plastically moulded PLA film of this type and to a method for producing said packaging and the use thereof.

The present invention relates to a process for the production of biodegradable packaging starting from a biaxially stretched, biodegradable film. The use of plastic packaging has increased considerably in recent decades. Plastic packaging offers protection against moisture and dirt, safeguards hygiene, provides an attractive appearance and protects the packaged goods against misuse with use of a comparatively small amount of material. Disposal of these materials has now become a problem which is growing in the same way. Recycling systems are being developed only very slowly, have questionable effectiveness and are often only implemented regionally, for example in Germany. In addition, petroleum as the natural starting material for polyolefinic thermoplastics is limited. These circumstances result in the basic requirement for suitable packaging materials made from renewable raw materials which can in addition be disposed of in an environmentally friendly manner.

This need has resulted in the development of polymers whose preparation chain begins with renewable raw materials. Examples thereof are polymers and copolymers of lactic acids and other hydroxycarboxylic acids, referred to below as PLAs. These are hydrolysed slowly at a certain atmospheric humidity level and elevated temperature and ultimately decompose to form water and CO₂. These polymers are therefore known as degradable polymers and can be prepared from vegetable renewable raw materials. PLA is prepared on an industrial scale by ring-opening polymerisation of a cyclic lactic acid dimer which is known as lactide. Corresponding processes are known from the prior art and are described, for example, in U.S. Pat. No. 1,995,970 or U.S. Pat. No. 2,362,511.

Besides the raw materials per se, film products made from PLA are also known from the prior art. For example, U.S. Pat. No. 5,443,780 describes the production of oriented films made from PLA. The process starts from a PLA melt, which is extruded and rapidly cooled. This pre-film can subsequently be subjected to a uniaxial stretching process or stretched sequentially or simultaneously biaxially. The stretching temperature is between the glass transition temperature and the crystallisation temperature of the PLA. The stretching results in increased strength and a higher Young's modulus in the final film. If desired, the stretching is followed by heat-setting.

The prior art furthermore discloses that non-oriented materials made from thermoplastic polymers can be processed into mouldings by thermoforming. The use of non-oriented PLA films for thermoforming is also known. For example, Schlicht in Kunststoffe 88, (1998) 6, pp. 888-890, describes the thermoforming of thick PLA cast film for the production of yoghurt pots. In order to achieve the requisite inherent strength of the pot, the starting material here is a thick film. The mouldings produced in this way usually have wall thicknesses of several 100 μm. In this way, a fully compostable yoghurt pot is obtained which can be disposed of in an environmentally friendly manner and with no residues.

DE69224772T2 describes the production of laminates from PLA and leather, paper, cellulose, fabric, etc. The adhesives proposed are preferably degradable adhesives, such as, for example, glue, gelatine, casein and starch. Application of an organotitanium compound, organosilane compound or polyethyleneimine as adhesive layer is likewise described as advantageous.

EP-A-0514137 describes the production of a laminate from a layer based on polylactic acid and a layer of regenerated cellulose, paper, leather, cloth or fibres. In both cases, the sheet-like composites are subsequently further processed into mouldings.

DE 69317474T2 describes the preparation of a composite material having improved gas barrier properties. These gas barrier properties are achieved by coating a PLA film with aluminium.

A further development in the area of environmentally friendly packaging materials is concerned with replacement of polystyrene containers and trays by corresponding mouldings based on starch or other degradable polymers. An essential disadvantage of these mouldings based on starch is the poor stability to aqueous or moist contents. The starch takes up the moisture, becomes soggy and loses all mechanical stability. Mouldings made from starch cannot be used for such applications. Although it is in principle possible to make these starch mouldings sufficiently water-repellent by means of corresponding coatings, these coatings are, however, themselves usually not made from a renewable raw material and are not biodegradable, meaning that the environmental compatibility of the composite as a whole is no longer guaranteed.

The object of the present invention was to provide environmentally friendly packaging which firstly can be produced from renewable raw materials and secondly can be disposed of in an environmentally friendly manner, preferably can be composted under suitable conditions.

This object is achieved by a process for the plastic deformation of a biaxially stretched PHC, preferably PLA film, in which a biaxially stretched PHC film is warmed to an elevated temperature and plastically shaped through the action of pneumatic and/or mechanical forces, and by a plastically shaped PHC film produced by this process.

This object is furthermore achieved through the use of a biaxially stretched, plastically shaped PHC film for the production of packaging.

The object is furthermore achieved by a process for the production of packaging which comprises, as constituent, a biaxially stretched, plastically shaped PHC film.

Further solutions to the object are indicated in the independent claims. The processes, uses and subject-matters of the dependent sub-claims are preferred embodiments of the invention.

For the purposes of the present invention, mention is made from polymers based on hydroxycarboxylic acids PHCs (polyhydroxycarboxylic acids). These are taken to mean homopolymers or copolymers built up from polymerised units of hydroxycarboxylic acids. Of the PHCs which are suitable for the present invention, polylactic acids are particularly suitable. These are referred to below as PLA (polylactide acid). Here too, the term is taken to mean both homopolymers built up only from lactic acid units and copolymers comprising predominantly lactic acid units (>50%) in compounds with other hydroxylactic acid units.

Analogously, the term PHC film or PLA film is taken to mean single-layered or multilayered films which comprise at least 80% by weight of a PHC or PLA in their base layer or in the layer in the case of single-layered embodiments. BOPHC or BOPLA denotes biaxially oriented PHC film or biaxially oriented PLA film.

The term “biaxially stretched PHC film, preferably PLA film” means, in the following description, that biaxially stretched films made from polyhydroxycarboxylic acid, i.e. biaxially oriented PHC films in the sense of the above definition, are basically suitable for the particular application. However, preference is given to the use of a biaxially stretched film made from polylactic acid, i.e. a biaxially stretched PLA film in the sense of the above definition.

For the purposes of the invention, “plastically shaped PHC film, preferably PLA film” means that the respective film is firstly produced separately as a biaxially oriented film and then shaped by the process according to the invention. Here too, the reference to “preferably PLA” means that the PLA film is preferred.

The biaxially stretched, plastically shaped PHC film, preferably PLA film, is produced by a process in which a biaxially stretched PHC film, preferably PLA film, is plastically shaped at elevated temperature under the action of pneumatic forces or through the mechanical action of moulds or through a combination of pneumatic and mechanical forces. The plastic shaping by means of pneumatic forces can be carried out by means of a reduced pressure (thermoforming) or excess pressure, i.e. compressed air. Processes of this type are disclosed in the prior art. The processes and their detailed form are described, for example, in Rosato's Plastics Encyclopedia and Dictionary, pages 755 to 766, which is expressly incorporated herein by way of reference. The processes according to the invention for the shaping of biaxially stretched PHC film, preferably PLA film, of the present invention can be carried out in accordance with the principles and modifications described therein for unstretched materials. Processes of this type for the plastic shaping of biaxially stretched PHC film, preferably PLA film, at elevated temperature under the action of pneumatic and/or mechanical forces are, for the purposes of the present invention, referred to in summary as shaping or plastic shaping.

Plastic shaping under the action of pneumatic forces is carried out, for example, by means of a reduced pressure and is then also known as thermoforming. In the thermoforming of biaxially oriented PHC film, preferably PLA film, the prefabricated, biaxially stretched PHC film, preferably PLA film, is laid over a suitable moulding, which is thus sealed off in an air-tight manner. A reduced pressure or vacuum is applied to the moulding in a suitable manner. Owing to the pressure difference between the vacuum chamber and the environment, suction acts on the film functioning as seal. Warming of the film with the aid of a heating element (5) increases the deformability of the film. The heating element is installed above the film surface and thus takes care of the warming of the film before the shaping step. When the film has been sufficiently warmed, it deforms in the direction of the moulding. The temperature, reduced pressure and the sequence of action are selected in the process in such a way that the film comes into positive contact with the moulding. After elimination of the pressure difference and cooling, the film retains its shape; it has been plastically shaped.

In an advantageous embodiment of the thermoforming process according to the invention, the actual shaping step is followed by additional setting, in which the shaped film is held at a temperature of 100-140° C. for a period of from 10 to 120 seconds, preferably from 20 to 60 seconds, while retaining the shaping forces, before the action of force is terminated and the film is cooled.

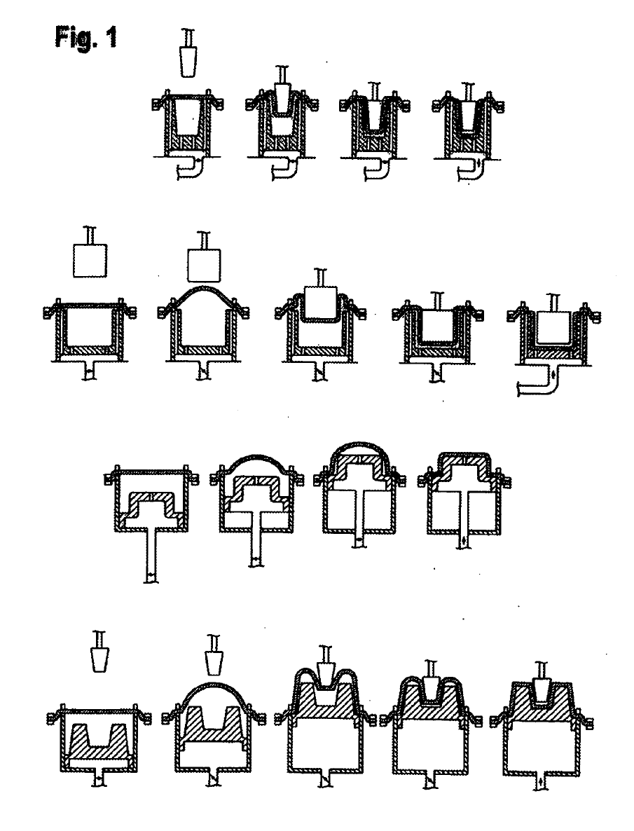

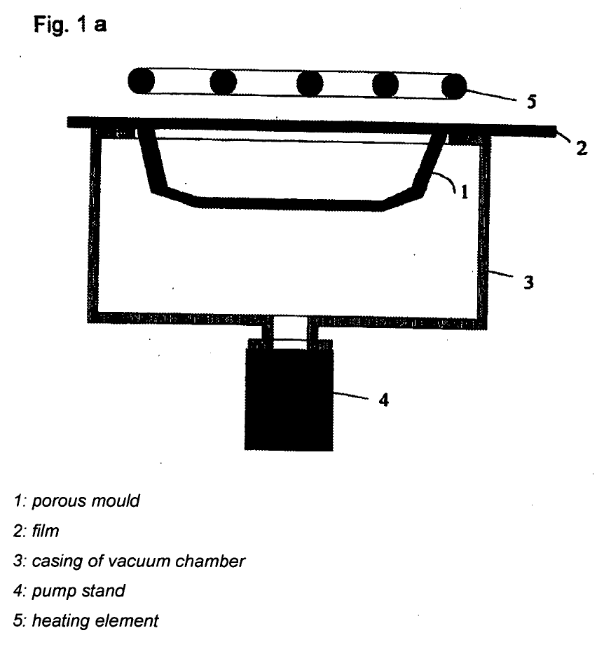

Various embodiments of the thermoforming processes are depicted by way of example in FIG. 1 and show diagrammatically devices for the thermoforming of the biaxially stretched PHC film, preferably PLA film.

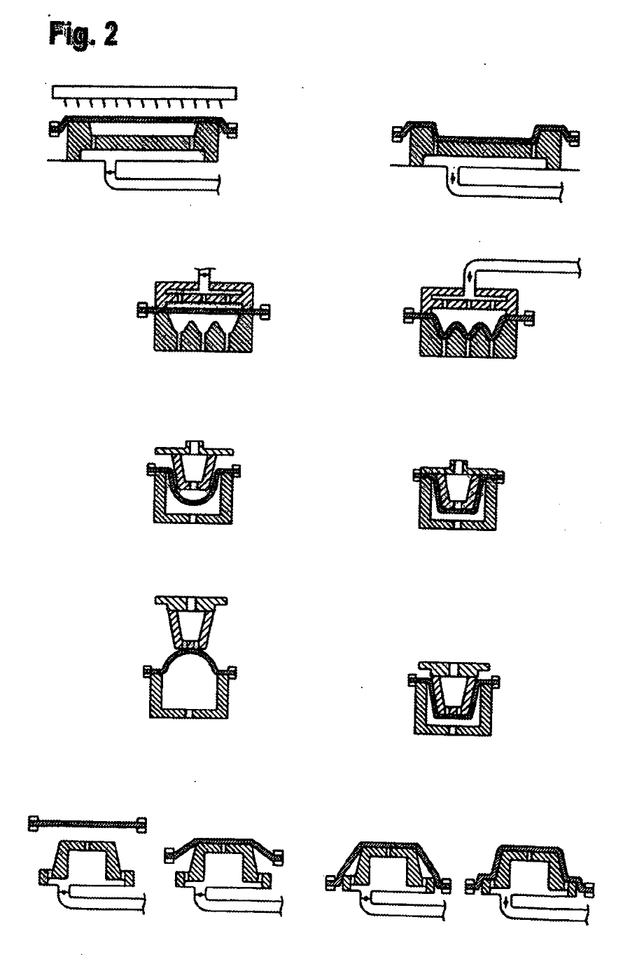

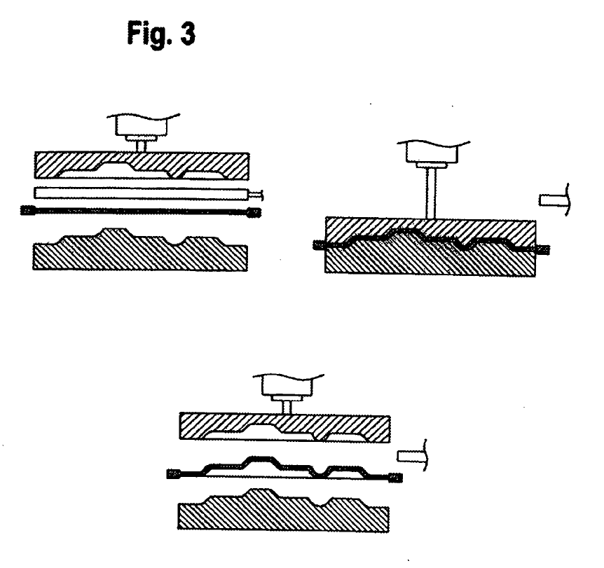

Further shaping processes are depicted in FIGS. 2 and 3.

In the processes according to the invention for the plastic shaping of the biaxially oriented PHC film, preferably PLA film, at elevated temperature, any desired suitable moulds which can be evacuated can in principle be employed. In a particularly advantageous embodiment of the invention, the mould used is a shaped support of a porous material or a support provided with aeration devices which can itself be employed as a composite with the plastically shaped PHC film, preferably PLA film, as container, for example tray or pot, for the pack contents. The material of the shaped support which is porous or provided with an aeration device and which is employed as mould is preferably made from a renewable raw material and, like the PHC film, preferably PLA film, is degradable. Porous moulds which are used as containers are, for example, made from starch, based on cellulose, for example made from paper or cardboard, or made from materials such as peat, cork, etc., of which starch is preferred.

For the shaping, for example in the thermoforming described above, the biaxially stretched PHC film, preferably PLA film, is warmed to a suitable temperature of from 50 to 150° C., preferably from 60 to 130° C., in particular from 80 to 120° C. This warming is in the simplest case carried out by means of a heating device installed in the spatial vicinity of the film, usually above it. Suitable heating devices are, for example, infrared emitters or hot-air fans. Suitable film structures for the shaping are described in detail below.

Surprisingly, it is possible to plastically shape the biaxially stretched PHC film, preferably PLA film, by means of pneumatic and/or mechanical forces at elevated temperature after stretching. This is not possible with conventional biaxially oriented films made from thermoplastics, such as, for example, BOPP. The mechanical strengths of the conventional biaxially stretched films are, owing to the orientation, so high that cracks or hole formation occur during the action of reduced pressure or excess pressure or during mechanical shaping of such films or the deformation is inadequate.

The plastically shaped PHC film, preferably PLA film, can be employed in various ways for the production of packaging. For example, the plastically shaped PHC film, preferably PLA film, can be applied as lid film to correspondingly shaped supports in the form of trays or containers which themselves require additional protection, for example against moisture. In this case, a combination of a plastically shaped PHC film, preferably PLA film, and a porous moulding, for example made from starch, of cellulose material, cork, etc., is particularly preferred.

The coating or lamination of the shaped supports with the plastically shaped PHC film, preferably PLA film, can be carried out in a suitable manner For example, partial adhesive bonding of the plastically shaped PHC film, preferably PLA film, to the shaped support may be sufficient. For other cases, adhesive bonding over the entire surface is desired.

In a further embodiment, the lamination process of the film to the shaped support can be carried out in a single working step with the shaping of the biaxially oriented PHC film, preferably PLA film, for example by thermoforming, blow moulding and/or mechanical deformation. In this case, use can be made of either a single-layered biaxially oriented PHC film, preferably PLA film, or a multilayered biaxially oriented PHC film, preferably PLA film, which is provided with a surface layer which can be heat-sealed or adhesively bonded to the moulding. The multilayered biaxially oriented PHC film, preferably PLA film, is positioned above the moulding during shaping in such a way that any adhesively bondable or heat-sealable surface layer is facing the moulding. During shaping, temperature and excess pressure or reduced pressure and/or the action of mechanical force by the mould result in adhesion between the surface of the shaped support and the surface of the PHC film, preferably PLA film, while the film comes into positive contact with the shaped support serving as a mould during the shaping process. If necessary, the shaped support is likewise warmed during shaping of the PHC film, preferably PLA film, in order to support the heat-sealing or lamination process, i.e. the formation of adhesion between the film and the shaped support.

A suitably coated PHC or PLA film for this embodiment of the invention is produced either by coextrusion or in-line or off-line coating of the biaxially stretched PHC film, preferably PLA film, is also possible. Suitable coating materials are conventional adhesives, cold-sealing coatings, PLA copolymers or mixtures of copolymers with PLA. In a further advantageous embodiment, the biaxially oriented PHC or PLA film consists only of a single layer into which an adhesively bondable component is incorporated during the extrusion process.

The above-described materials, such as starch, paper, cardboard, etc., for the support are equally suitable and advantageous as shaped supports in this combined process since they are likewise made from renewable raw materials and are degradable. Materials having lower porosity into which aeration devices are incorporated are likewise suitable. Suitable materials are, for example, wood, metals or ceramics. The support simultaneously employed as mould should basically have such a spatial three-dimensional shape that it is suitable for the accommodation of pack contents. Any desired shapes are suitable here, such as, for example, dishes, pots, trays or other container-like shapes.

In a further use, the plastically shaped PHC film, preferably PLA film, can be used for the production of a so-called blister pack. In this case, for example, the plastically shaped PHC film, preferably PLA film, is filled with the pack contents and sealed with a sheet-like support. The PHC or PLA film here is partially heat-sealed or adhesively bonded to the support. The raw materials employed for the support are preferably compostable materials made from renewable raw materials, for example starch, cellulose-based materials and compostable films of suitable thickness.

For the various shaping processes for the production of the plastically shaped PHC film, preferably PLA film, both single-layered and multilayered biaxially oriented PHC film, preferably PLA film, can in principle be employed. Multilayered films are generally built up from a base layer, which has the greatest layer thickness, and at least one top layer, where basically the same raw materials as in the base layer can be used for the top layer. If desired, it is also possible to employ modified PLA raw materials in the top layer. The top layer(s) is (are) either applied to the surface of the base layer or to the surface of any interlayer additionally present.

The base layer or the layer in the case of single-layered embodiments of the BOPHC or BOPLA film generally comprises at least 80% by weight, preferably from 90 to 100% by weight, in particular from 98 to <100% by weight, in each case based on the layer, of a polyhydroxy acid and from 0 to 20% by weight, or from 0 to 10% by weight or from 0 to 2% by weight respectively of conventional additives. Suitable monomers of the polyhydroxy acid are, in particular, mono-, di- or trihydroxycarboxylic acids or dimeric cyclic esters thereof, of which lactic acid in its D or L form is preferred. A particularly suitable PLA is polylactic acid from Cargill Dow (NatureWorks®). The preparation of this polylactic acid is known from the prior art and is carried out via catalytic ring-opening polymerisation of lactide(1,4-dioxane-3,6-dimethyl-2,5-dione), the dimeric cyclic ester of lactic acid, for which reason PLA is also frequently known as polylactide. The preparation of PLA has been described in the following publications: U.S. Pat. No. 5,208,297, U.S. Pat. No. 5,247,058 and U.S. Pat. No. 5,357,035.

Preference is given to polylactic acids built up exclusively from lactic acid units. Of these, particular preference is given to PLA homopolymers comprising 80-100% by weight of L-lactic acid units, corresponding to from 0 to 20% by weight of D-lactic acid units. In order to reduce the crystallinity, even higher concentrations of D-lactic acid units may also be present as comonomer. If desired, the polylactic acid may additionally comprise polyhydroxy acid units other than lactic acid as comonomer, for example glycolic acid units, 3-hydroxypropanoic acid units, 2,2-dimethyl-3-hydroxy-propanoic acid units or higher homologues of the hydroxycarboxylic acids having up to 5 carbon atoms.

Preference is given to lactic acid polymers having a melting point of from 110 to 170° C., preferably from 125 to 165° C., and a melt flow index (measurement DIN 53 735 at a load of 2.16 N and 190° C.) of from 1 to 50 g/10 min, preferably from 1 to 30 g/10 min, in particular 1-6 g/10 min. The molecular weight of the PLA is in the range from at least 10,000 to 500,000 (number average), preferably from 50,000 to 300,000 (number average). The glass transition temperature Tg is in the range from 40 to 100° C., preferably from 40 to 80° C.

In addition, the base layer or the layer of the PLA film may comprise conventional additives, such as neutralisers, stabilisers, antistatics and/or lubricants, in effective amounts in each case.

The PHC film, preferably PLA film, optionally comprises a top layer of polyhydroxy acids on one or both sides, generally applied to the base layer. The top layer(s) generally comprise(s) from 85 to 100% by weight of polyhydroxy acids, preferably from 90 to <100% by weight of polyhydroxy acids, and from 0 to 15% by weight or from >0 to 10% by weight respectively of conventional additives, in each case based on the weight of the top layer(s).

Examples of suitable polyhydroxy acids of the top layer(s) are polylactic acids built up exclusively from lactic acid units. Particular preference is given here to PLA homopolymers comprising 80-100% by weight of L-lactic acid units, corresponding to from 0 to 20% by weight of D-lactic acid units. In order to reduce the crystallinity, even higher concentrations of D-lactic acid units may also be present as comonomer. If desired, the polylactic acid may additionally comprise polyhydroxy acid units other than lactic acid as comonomer, as described for the base layer.

For the top layer(s), lactic acid polymers having a melting point of from 110 to 170° C., preferably from 125 to 165° C., and a melt flow index (measurement DIN 53 735 at a load of 2.16 N and 190° C.) of from 1 to 50 g/10 min, preferably from 1 to 30 g/10 min, in particular 1-6 g/10 min, are preferred. The molecular weight of the PLA is in the range from at least 10,000 to 500,000 (number average), preferably from 50,000 to 300,000 (number average). The glass transition temperature Tg is in the range from 40 to 100° C., preferably from 40 to 80° C. For the top layer, PLA having a higher MFI in the preferred range of 2-4 g/10 min is particularly suitable.

In a further embodiment, the top layer may also be built up from conventional polyesters, such as polyethylene terephthalates PETs or polybutylene terephthalates PBTs, or mixtures of PET and PLA or PBT and PLA or PET, PBT and PLA mixtures.

If desired, the additives described above for the base layer, such as antistatics, neutralisers, lubricants and/or stabilisers, and optionally additionally antiblocking agents may be added to the top layer(s).

The thickness of the top layer(s) is greater than 0.1 μm and is preferably in the range from 0.1 to 5 μm, in particular from 0.5 to 3 μm, where top layers on both sides may have identical or different thicknesses. The total thickness of the BOPHC or BOPLA film can vary and is preferably from 10 to 100 μm, in particular from 15 to 50 μm, where the base layer in the case of multilayered embodiments makes up from about 40 to 98% of the total film thickness.

The single-layered or multilayered biaxially oriented film will be produced by the stenter or blowing process known per se.

In the stenter process, the melts corresponding to the individual layers of the film are extruded or coextruded through a flat-film die, the resultant film is taken off over one or more roll(s) for solidification, the film is subsequently stretched (oriented), and the stretched film is heat-set.

Biaxial stretching (orientation) is carried out sequentially or simultaneously. Sequential stretching is generally carried out successively, with successive biaxial stretching, in which stretching is firstly carried out longitudinally (in the machine direction) and then transversely (perpendicular to the machine direction), being preferred. The further description of the film production uses the example of flat-film extrusion with subsequent sequential stretching.

Here, as usual in the extrusion process, the polymer or polymer mixture of the individual layers is compressed and liquefied in an extruder, where any additives added may already be present in the polymer or in the polymer mixture.

The melt(s) is (are) then forced through a flat-film die (slot die), and the extruded film is taken off over one or more take-off rolls at a temperature of from 10 to 100° C., preferably from 20 to 60° C., during which it cools and solidifies.

The resultant film is then stretched longitudinally and transversely to the extrusion direction, which results in orientation of the molecular chains. The longitudinal stretching is preferably carried out at a temperature of from 50 to 150° C., advantageously with the aid of two rolls running at different speeds corresponding to the target stretching ratio, and the transverse stretching is preferably carried out at a temperature of from 50 to 150° C. with the aid of a corresponding tenter frame. The longitudinal stretching ratios are in the range from 1. 5 to 6, preferably from 2 to 4. The transverse stretching ratios are in the range from 3 to 10, preferably from 4 to 7.

The stretching of the film is followed by heat-setting (heat treatment) thereof, during which the film is held at a temperature of from 60 to 150° C. for from about 0.1 to 10 seconds. The film is subsequently wound up in a conventional manner using a wind-up device.

The invention is explained below with reference to working examples.

Part A. Production of the Biaxially Stretched PLA Film

### EXAMPLE 1

A transparent single-layered PLA film having a thickness of 30 μm was produced by extrusion and subsequent stepwise orientation in the longitudinal and transverse directions. The layer was built up from a polylactic acid having a melting point of 135° C. and a melt flow index of about 3 g/10 min and a glass transition temperature of about 60° C. and comprised stabilisers and neutralisers in conventional amounts. The production conditions in the individual process steps were as follows:

| | | | |
|---|---|---|---|
| Extrusion: | Temperatures: | Base layer: | 195° C. |
| | | Top layers: | 180° C. |

| | | |
|---|---|---|
| | Temperature of take-off roll: | 45° C. |
| Longitudinal stretching: | Temperature: | 50° C. |
| | Longitudinal stretching ratio: | 3 |
| Transverse stretching: | Temperature: | 82° C. |
| | Transverse stretching ratio (effec- | 5.5 |
| | tive): | |
| Setting: | Temperature: | 75° C. |
| | Convergence: | 5% |

### EXAMPLE 2

A transparent three-layered film having a symmetrical structure and a total thickness of 40 μm was produced by coextrusion and subsequent stepwise orientation in the longitudinal and transverse directions. The top layers each had a thickness of 1.5 μm. The base layer was built up from a polylactic acid having a melting point of 135° C. and a melt flow index of about 3 g/10 min and a glass transition temperature of 60° C. The top layers were built up from a polylactic acid having a melt flow index of about 3.6 g/10 min. All layers comprised stabilisers and neutralisers in conventional amounts.

The production conditions in the individual process steps were as follows:

| | | | |
|---|---|---|---|
| Extrusion: | Temperatures: | Base layer: | 195° C. |
| | | Top layers: | 175° C. |

| | | |
|---|---|---|
| | Temperature of take-off roll: | 45° C. |
| Longitudinal stretching: | Temperature: | 50° C. |
| | Longitudinal stretching ratio: | 3 |
| Transverse stretching: | Temperature: | 85° C. |
| | Transverse stretching ratio (effec- | 5.5 |
| | tive): | |
| Setting: | Temperature: | 75° C. |
| | Convergence: | 5% |

### PART B PLASTIC SHAPING OF THE BIAXALLY STRETCHED FILMS ACCORDING TO EXAMPLE 1

The thermoforming mould used was a porous moulding made from starch which does not bond to the film. The film was stretched over the porous starch moulding and sealed in an air-tight manner. After the film had been warmed to a temperature of 90° C., a reduced pressure of 1 bar was generated. Under the action of the reduced pressure, the film came into positive contact with the porous moulding. After cooling, the film remained in this shape.

### PART B PLASTIC SHAPING OF THE BIAXALLY STRETCHED FILM ACCORDING TO EXAMPLE 1

The film was thermoformed as described in Part B for Example 1 over a moulding made from starch. During thermoforming, adhesion formed between the starch tray and the thermoformed PLA film.

1. Process for the plastic shaping of a biaxially stretched PHC film, preferably PLA film, characterised in that a biaxially stretched PHC film, preferably PLA film, is warmed to an elevated temperature and plastically shaped through the action of pneumatic and/or mechanical forces.

2. Process according to claim 1, characterised in that the biaxially oriented PHC film, preferably PLA film, is warmed to a temperature of from 50 to 150° C., preferably to a temperature of from 60 to 130° C.

3. Process according to claim 2, characterised in that the biaxially oriented PHC film, preferably PLA film, is warmed by means of IR emitters and/or hot air and/or hot steam.

4. Process according to claim 1, characterised in that the pneumatic forces act on the biaxially oriented PHC film, preferably PLA film, as reduced pressure or excess pressure.

5. Process according to claim 4, characterised in that the shaping of the biaxially oriented PHC film, preferably PLA film, is carried out by means of thermoforming.

6. Process according to claim 1, characterised in that the biaxially oriented PHC film, preferably PLA film, has a thickness of from 40 to 100 μm before the shaping.

7. Process according to claim 1, characterised in that the biaxially oriented PHC film, preferably PLA film, comes into positive contact with the mould under the action of the pneumatic and/or mechanical forces.

8. Biaxially stretched PHC film, preferably PLA film, produced in accordance with claim 1, characterised in that the biaxially stretched film has been plastically shaped.

9. Use of a biaxially stretched and subsequently plastically shaped PHC film, preferably PLA film, produced in accordance with claim 1 for the production of packaging.

10. Packaging produced by a use according to claim 9.

11. Use of a biaxially stretched and subsequently plastically shaped PHC film, preferably PLA film, for the production of packaging according to claim 1.

12. Packaging, characterised in that the packaging comprises a biaxially stretched and subsequently plastically shaped PHC film, preferably PLA film according to claim 1.

13. Packaging according to claim 12, characterised in that the plastic shaping of the biaxially stretched PHC film, preferably PLA film, was carried out at an elevated temperature and through the action of pneumatic and/or mechanical forces.

14. Process for the production of packaging from a shaped support, characterised in that a biaxially stretched and subsequently plastically shaped PHC film, preferably PLA film, is applied to a support of the same shape by means of lamination, adhesive bonding or heat-sealing.

15. Process according to claim 14, characterised in that the plastic shaping of the biaxially stretched PHC film, preferably PLA film, was carried out at an elevated temperature and through the action of pneumatic and/or mechanical forces.

16. Process according to claim 14, characterised in that the mould used during production of the plastically shaped PHC film, preferably PLA film, has the same spatial shape as the shaped support.

17. Process according to claim 14, characterised in that the shaped support is built up from starch, paper or cardboard.

18. Process according to claim 14, characterised in that the adhesive bonding of the PHC film, preferably PLA film, to the shaped support is carried out over the entire surface or part of the surface or in a punctiform manner.

19. Process according to claim 14, characterised in that the shaped support has the shape of a container, preferably a pot or tray.

20. Packaging produced by a process according to claim 14.

21. Process for the production of packaging from a shaped support, characterised in that a biaxially stretched PHC film, preferably PLA film, is plastically shaped at elevated temperature under the action of pneumatic and/or mechanical forces using a mould which itself forms the shaped support of the packaging, and adhesion is produced between the surface of the shaped support and the surface of the PLA film during the plastic shaping of the biaxially stretched PHC film, preferably PLA film according to claim 1.

22. Process according to claim 21, characterised in that the biaxially stretched PHC film, preferably PLA film, is a multilayered film and has at least one top layer which is heat-sealable to the surface of the shaped support at the temperature at which the shaping process is carried out, and the heat-sealable top layer faces the shaped support which constitutes the mould during the shaping.

23. Process according to claim 21, characterised in that the biaxially stretched PHC film, preferably PLA film, is a coated film and has at least one coating which can adhere or stick to the surface of the shaped support at the temperature at which the shaping process is carried out, and the coating faces the shaped support which constitutes the mould during the shaping.

24. Process according to claim 23, characterised in that the coating of the biaxially stretched PHC film, preferably PLA film, takes place during or after production of the biaxially stretched PHC film, preferably PLA film.

25. Process according to claim 21, characterised in that the shaped support is likewise warmed during the shaping of the biaxially stretched PHC film, preferably PLA film.

26. Process according to claim 21, characterised in that the shaped support is made from a porous material, and the shaping of the PHC film, preferably PLA film, is carried out by means of thermoforming.

27. Process according to claim 21, characterised in that the shaped support has the shape of a container, preferably a pot or tray.

28. Packaging produced in accordance with claim 21.

29. Process for the production of a blister pack comprising a sheet-like support, characterised in that a biaxially stretched and subsequently plastically shaped PHC film, preferably PLA film, is connected to the sheet-like support by means of lamination, adhesive bonding or heat-sealing.

30. Blister pack produced in accordance with claim 29.

31. Use of packaging according to claim 10 for the packaging of foods, requisites, consumer products or pharmaceutical products.

32. Packaging according to claim 10, characterised in that the PHC film, preferably PLA film, is built up from a plurality of layers.

33. Packaging according to claim 32, characterised in that at least one top layer of the film is heat-sealable.

34. Packaging according to claim 10, characterised in that the PHC film, preferably PLA film, has a coating on at least one surface.

35. Packaging according to claim 10, characterised in that the PLA film is built up from a polylactic acid which comprises 80-100% by weight of L-lactic acid units and from 0 to 20% by weight of D-lactic acid units or other polyhydroxycarboxylic acid units.

36. Process according to claim 10, characterised in that the biaxially oriented PHC film, preferably PLA film, has a thickness of from 15 to 100 μm before the shaping process.
